(19) United States
(12) Patent Application Publication
(10) Pub. No.: US 2022/0200324 A1
(43) Pub. Date: Jun. 23, 2022

(54) COIN OPERATED SOLAR CHARGING STATION

(71) Applicant: Martin Wadinga Caspa, Corona, CA (US)

(72) Inventor: Martin Wadinga Caspa, Corona, CA (US)

(21) Appl. No.: 17/127,832

(22) Filed: Dec. 18, 2020

(51) Int. Cl. H02J 7/35; H02J 7/00

(52) U.S. Cl. CPC H02J 7/35; H02J 7/0047; H02J 7/0029

(57) ABSTRACT

A device comprising of a commercial grade Cellphone charging station, wherein the whole system is a standalone and solar powered for cellphone charging. The system will be tracked and traceable upon any displacement for original location. A device will collect the sun's rays using a solar panel during the day, and convert it to electrical power for usage in the day and nighttime. A device will store or retain the converted electrical power in a storage, Lead Acid Battery bank. A device will consist of a charge controller to regulate the charging process. A device according will have an operating face comprising of USB ports, coin processing device, and also a magnetic stripe and credit card swipe device as a form of payment for power charging service. A will comprise a Wi-Fi device/interface card for remote access.

### FIELD OF THE INVENTION

This invention relates in general to a coin operated solar charging station.

### BACKGROUND OF THE INVENTION

NONE

### SUMMARY OF THE INVENTION

For the sake of consistent communication connection fail safe, safety and most importantly, conserving grid power for critical uses/application, tapping from the sun and making electrical power available off-grid anywhere or everywhere freeing the grid during high load requirement distribution is a must. With that said and understood, there is a need to develop and establish an off-grid system for power anywhere application. Specifically for the use of the mass produced cellphones manufacturing and sales today and in the future. This is a call that will effectively serve the homeless population who have phones but with no home base for convenient charging.

Power needs and users should be able to get power anywhere anytime without depending on the grid especially where there is no grid or mobile source of power for communication devices. (Recreational parks, mountain and hiking trails, rest stops, freeways etc.)

Just as with the convenience of gas stations everywhere we need cell phone charging stations everywhere anywhere/anytime as needed with a power anywhere/off-grid power self-generation and delivery.

Using the self-generation concept and solamatic intelligent, (my first IP) I have created, developed and established a Solar Operated commercial grade Cellphone Charging Station, integrated with a coin operated device, potentials of a mag-stripe or any card reader device. The charging station system is integrated with a token or coin acceptance system or a potential mag-swipe device for service payment processing, if it is commercially deployed otherwise it's on automatic charging mode at install. The system is integrated with an automatic twelve hour run LED lighting for safety of users, and capabilities of unattended features. This charging station system will be attended or unattended as need be. The charging station system is integrated with a printed wire board assembly (PWBA) to operate with an Arduino. With a little programing of the Arduino device, the system is configured to activate the Arduino to control the coin identification, acceptance or reject functions on insert. The system will initiate a time phased power dispensing when inserted the right coin or token configuration and/or card reader device to provide a time phased charging service for numerous cellphones or any USB based device as need be. The charging station system will be fixed or mobile as need be.

Power Source, Harnessing and Charging Station's System Load:

The charging station will compose of an overhead solar panel assembly (FIG. 1 #1) with a harness routed, in a conduit post (FIG. 1 #4) that has adjustable height to any desired height, with a maximum height of seventy five inches (75″). Using conduit couplings (FIG. 1 #3) to connect the panel to a flat bracket to securely hold the entire assembly. There will be a canopy cover in-between the solar panel and the panel's bracket (FIG. 1 #2) to protect end user from sun or rain during device charging. The solar panel collect's the sun's rays with designed-in photo voltaic cells. The collected sun's ray is now converted to electrical energy and then harnessed with integrated harness and terminal connectors, through a charge controller to a storage bank (Lead Acid Battery) securely placed in an electrical metal enclosure. The storage bank and enclosure will be populated with a solar charge controller connected to battery to regulate the charging and discharging process day and night in the system. The saved power will also feed the Arduino, mag-swipe card reader devises, inverter units, the USBs the volt meter for power threshold level and charging power indicator LED on the PWBA and Arduino. Plus a final load of an LED light bulb for automatic lighting at night to enhance safety to end users during night charging.

Power Storage Usage, Delivery and Service Availability

The systems enclosure (FIG. 1 #7) is designed with built-in racks for the systems critical components (charge controller, Arduino, PWBA stacking and will be populated with a Lead Acid Battery for the entire storage function. The user interface portion of the storage container is populated with fast charge USB ports, the internal portion has the charge controller, inverter, and user interface capability to connect and get a device fully charged for use without damage. When the battery bank is fully charged the charge controller will regulate process to stop charging, avoiding battery and charging system damage. The storage box will be integrated with coin operated device to accept or reject coins or token when the wrong coin or token is inserted. The coin acceptance device is populated with a solenoid to identify or reject wrong coins or tokens. The storage/enclosure box will accommodate a card reader that gets its power from the main storage battery to operate. There also will be an automatic LED for power indicator built into the USB Charging ports during or all times the system is operational visible to the end user to indicate system charging function is on. LED will turn off when charging is over or the time phased coin is done. The system will start charging the battery at sunrise and will stop when battery is full. During the day the system will execute its direct charge process without using its stored charge current till the night time then the stored charge kicks-in. With this process a continuous supply or charge power is available to the end user at all times independent of its load draw. The system will have an integrated server interface card (FIG. 1 #21) for remote power level monitoring and data collection for system management. The charge controller shall be a Maximum Power Point Tracker (MPPT), to be able to collect the sun's rays in bad sunny days so no failure will be experienced over the life of the system.

Structural Appearance:

The solar panel assembly (FIG. 1 #1) will be positioned on top of the systems canopy (FIG. 1 #2) all together held securely in place with a coupling link (FIG. 1 #3) and flat bracket (FIG. 1 #17). A conduit/post (FIG. 1 #4) runs straight up to the solar panel assembly and held securely in place by a coupling (FIG. 1 #3) attached to the solar panel assembly with flexibility of a vertical additions to a maximum height of seventy five inches (75″). The solar panels can be scaled up with horizontal connections on systems to increase power/current (wider solar array configurations). Basically properly affixed on a durable conduit post on a flat bracket with horizontal bud-stacking to increase capacity of handling additional load/USB charge port connectors for several phones as need be. The post shall be segmented and connected by links/couplings (FIG. 1 #3) flexibly to a desired height. The storage box/enclosure may have individual cell phone lock and key feature for end users property protection as an option feature. The entire solar panel assembly will held together by a flat brackets with fasteners and top center link (FIG. 1 #3) securely fastened. The whole storage enclosure can also be configured with a formed rectangular wooden box vertically standing with internal LED lighting for any Advertisement signs if required. The system will be integrated with an overhead LED light fixture at the top (FIG. 1 #2)/bottom for surrounding illumination. The charging station is designed with capabilities of mobile on wheels (FIG. 1 #20) or fixed to the ground with cement concrete installation. The entire charging station will be installed outside and directly exposed to the sun all day. For safety purposes the charging station is integrated with automatic lighting (FIG. 1 #21) securely placed on the solar panel assembly to cast light downward for illumination of the charging station occupied space for safety of the consumer at night. The charging station will be designed with flexibility of a fixed or rolling on wheels from one location to another as desired for commercial relocation to high traffic areas.

Charging Process and Station Features:

The charging station system will be designed with fixed post and flexible features of an attended (operator assist) and unattended using a specific call-out mag. swipe card reader or coin insertion. Card swiping using an integrated card reader or coin/token drop slot, to activate charging through a specific port selected on the user interface portion of the enclosure box. The phone/device requiring a charge will be connected to a USB cord and the cord connected to a charge port on the user interface portion of the storage enclosure box/port in an electronically identified port for charging. The charging function can/will be actuated by a switch or automatic charging upon insert or coin/token insert/mag-swipe card, depending on user preference, then the specific charge port will be depicted with LED indicator permanently ON and charging begins. LED will stay ON for the duration of charge time, then automatically turn off on charge time complete.

The coin operated charging station's process will include:

Coin dropped in coin acceptor/processor, (FIG. 1 #10) the coins acceptor outputs a pulse to the Arduino (FIG. 1 #13), and the Arduino counts coin pulse.

End user/operator chooses a charging port (FIG. 1 #12) by pressing a corresponding switch button (FIG. 1 #11). Arduino multiplies number of coins by time interval to get the charge time Arduino sets internal timer for charge time, and turns ON the charge port and Arduino sets number of coins to zero for next coin drop. The charging process time will start or stop based on time purchased duration, then the charge indicator LED in the charge port in use will turn OFF. The charging station will also have flexibility of direct charge activation and electronic intelligence identification/Volt meter (FIG. 1 #5) for charging power threshold level/availability. The charging station will be designed with a location tracking system and accessibility by remote wireless device access, location identifier for theft traceable and consumer's service point identification. For safety purposes the systems will have integrated automatic LED lighting (an all-night location illumination) It will also be sized, capable of accommodating digital commercial load signs for any advertisement as need be. At night the system will automatically turn on the LED bulb (FIG. 1 #21) to provide illumination around the area for safety.

The charging station will be designed with a commercial grade charging capabilities for Cellphone Charging and will have the capabilities of charging function conducted using either of the listed features.

a. COIN/TOKEN

b. MAGSTRIPE SWIPE

c. CREDIT CARD

d. PHONE APP. ACTIVATED CHARGING

e. WI-FI FEATURES

The Commercial grade coin operated solar charger will be located/managed remotely as follows:

1. End users

a. Locate with an App. from the app store, the where about of a solar operated cellphone charger. (locate before phone goes bone dead)

2. Owners

Will be able to trace a displaced cellphone charging station anywhere at any time with Cellphone from the App. store. (Find my charging station command). (Initiate locate command function before phone goes bone dead)

### BRIEF DESCRIPTION OF DRAWINGS

These as well as other features of the present invention will become apparent upon reference to the accompanying drawings wherein like numerals designate corresponding parts in the several figures, summarized as follows:

FIG. 1 is an exploded view of the invention.

Other features and advantages of the invention will become apparent from the following detailed description, taken in conjunction with the accompanying drawings, which illustrate, by way of example, various features of embodiments of the invention.

### DETAIL DESCRIPTION OF PREFERRED EMBODIMENT

The following detailed description and accompanying drawings are provided for purpose of illustrating and describing precisely the preferred embodiments of the present invention and are not intended to limit the scope of the invention in anyway. It will be understood that various changes in the details, materials arrangements of parts or operational conditions which have been herein described and illustrated in order to explain the nature of the invention may be made by those skilled in the art within the principles and scope of this invention.

Power Source, Harnessing and Charging Station's System Load:

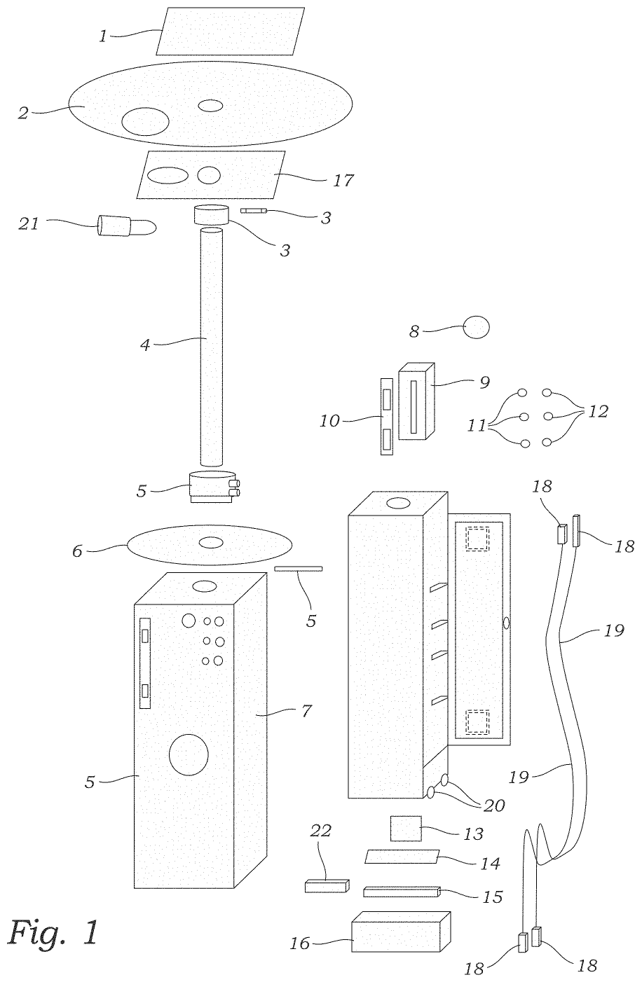

The charging station will compose of an overhead solar panel assembly (FIG. 1 #1) with a harness routed, in a conduit post (FIG. 1 #4) that has adjustable height to any desired height, with a maximum height of seventy five inches (75″). Using conduit couplings (FIG. 1 #3) to connect the panel to a flat bracket to securely hold the entire assembly. There will be a canopy cover in-between the solar panel and the panel's bracket (FIG. 1 #2) to protect end user from sun or rain during device charging. The solar panel collect's the sun's rays with designed-in photo voltaic cells. The collected sun's ray is now converted to electrical energy and then harnessed with integrated harness and terminal connectors, through a charge controller to a storage bank (Lead Acid Battery) securely placed in an electrical metal enclosure. The storage bank and enclosure will be populated with a solar charge controller connected to battery to regulate the charging and discharging process day and night in the system. The saved power will also feed the Arduino, mag-swipe card reader devises, inverter units, the USBs the volt meter for power threshold level and charging power indicator LED on the PWBA and Arduino. Plus a final load of an LED light bulb for automatic lighting at night to enhance safety to end users during night charging.

Power Storage Usage, Delivery and Service Availability

The systems enclosure (FIG. 1 #7) is designed with built-in racks for the systems critical components (charge controller, Arduino, PWBA stacking and will be populated with a Lead Acid Battery for the entire storage function. The user interface portion of the storage container is populated with fast charge USB ports, the internal portion has the charge controller, inverter, and user interface capability to connect and get a device fully charged for use without damage. When the battery bank is fully charged the charge controller will regulate process to stop charging, avoiding battery and charging system damage. The storage box will be integrated with coin operated device to accept or reject coins or token when the wrong coin or token is inserted. The coin acceptance device is populated with a solenoid to identify or reject wrong coins or tokens. The storage/enclosure box will accommodate a card reader that gets its power from the main storage battery to operate. There also will be an automatic LED for power indicator built into the USB Charging ports during or all times the system is operational visible to the end user to indicate system charging function is on. LED will turn off when charging is over or the time phased coin is done. The system will start charging the battery at sunrise and will stop when battery is full. During the day the system will execute its direct charge process without using its stored charge current till the night time then the stored charge kicks-in. With this process a continuous supply or charge power is available to the end user at all times independent of its load draw. The system will have an integrated server interface card (FIG. 1 #21) for remote power level monitoring and data collection for system management. The charge controller shall be a Maximum Power Point Tracker (MPPT), to be able to collect the sun's rays in bad sunny days so no failure will be experienced over the life of the system.

Structural Appearance:

The solar panel assembly (FIG. 1 #1) will be positioned on top of the systems canopy (FIG. #2) all together held securely in place with a coupling link (FIG. 1 #3) and flat bracket (FIG. 1 #17). A conduit/post (FIG. 1 #4) runs straight up to the solar panel assembly and held securely in place by a coupling (FIG. 1 #3) attached to the solar panel assembly with flexibility of a vertical additions to a maximum height of seventy five inches. (75″) The solar panels can be scaled up with horizontal connections on systems to increase power/current (wider solar array configurations). Basically properly affixed on a durable conduit post on a flat bracket with horizontal bud-stacking to increase capacity of handling additional load/USB charge port connectors for several phones as need be. The post shall be segmented and connected by links/couplings (FIG. 1 #3) flexibly to a desired height. The storage box/enclosure may have individual cell phone lock and key feature for end users property protection as an option feature. The entire solar panel assembly will held together by a flat brackets with fasteners and top center link (FIG. 1 #3) securely fastened. The whole storage enclosure can also be configured with a formed rectangular wooden box vertically standing with internal LED lighting for any Advertisement signs if required. The system will be integrated with an overhead LED light fixture at the top (FIG. 1 #2)/bottom for surrounding illumination. The charging station is designed with capabilities of mobile on wheels (FIG. 1 #20) or fixed to the ground with cement concrete installation. The entire charging station will be installed outside and directly exposed to the sun all day. For safety purposes the charging station is integrated with automatic lighting (FIG. 1 #21) securely placed on the solar panel assembly to cast light downward for illumination of the charging station occupied space for safety of the consumer at night. The charging station will be designed with flexibility of a fixed or rolling on wheels from one location to another as desired for commercial relocation to high traffic areas.

Charging Process and Station Features:

The charging station system will be designed with fixed post and flexible features of an attended (operator assist) and unattended using a specific call-out mag. swipe card reader or coin insertion. Card swiping using an integrated card reader or coin/token drop slot, to activate charging through a specific port selected on the user interface portion of the enclosure box. The phone/device requiring a charge will be connected to a USB cord and the cord connected to a charge port on the user interface portion of the storage enclosure box/port in an electronically identified port for charging. The charging function can/will be actuated by a switch or automatic charging upon insert or coin/token insert/mag-swipe card, depending on user preference, then the specific charge port will be depicted with LED indicator permanently ON and charging begins. LED will stay ON for the duration of charge time, then automatically turn off on charge time complete.

The coin operated charging station's process will include:

Coin dropped in coin acceptor/processor, (FIG. 1 #10) the coins acceptor outputs a pulse to the Arduino (FIG. 1 #13), and the Arduino counts coin pulse.

End user/operator chooses a charging port (FIG. 1 #12) by pressing a corresponding switch button (FIG. 1 #11). Arduino multiplies number of coins by time interval to get the charge time Arduino sets internal timer for charge time, and turns ON the charge port and Arduino sets number of coins to zero for next coin drop. The charging process time will start or stop based on time purchased duration, then the charge indicator LED in the charge port in use will turn OFF. The charging station will also have flexibility of direct charge activation and electronic intelligence identification/Volt meter (FIG. 1 #5) for charging power threshold level/availability. The charging station will be designed with a location tracking system and accessibility by remote wireless device access, location identifier for theft traceable and consumer's service point identification. For safety purposes the systems will have integrated automatic LED lighting (an all-night location illumination) It will also be sized, capable of accommodating digital commercial load signs for any advertisement as need be. At night the system will automatically turn on the LED bulb (FIG. 1 #21) to provide illumination around the area for safety.

### PARTS LIST

1—SOLAR PANEL
2—CANOPY
3—COUPLIN
4—CONDUIT
5—COUPLIN
6—CHARGING TABLE
7—ENCLOSURE
8—OHMS METER
9—COIN BOX
10—COIN RECEPTOR/PROCESSOR
11—SWITCHES
12—CHARGE PORTS
13—ARDUINO
14—PWBA
15—CHARGE CONTROLLER
16—STORAGE
17—FLAT BRACKET
18—HARNESS CONNECTOR
19—HARNESS
20—WHEELS
21—LED LIGHT BULB

Formal/Cad Technical Drawing Separate Page.

Charging Summary:

The charging station will be designed with a commercial grade charging capabilities for Cellphone Charging and will have the capabilities of charging function conducted using either of the listed features.

a. COIN/TOKEN

b. MAGSTRIPE SWIPE

c. CREDIT CARD

d. PHONE APP. ACTIVATED CHARGING

e. WI-FI FEATURES

The Commercial grade coin operated solar charger will be located/managed remotely as follows:

1. End users

a. Locate with an App. from the app store, the where about of a solar operated cellphone charger. (locate before phone goes bone dead)

2. Owners

Will be able to trace a displaced cellphone charging station anywhere at any time with Cellphone from the App. store. (Find my charging station command). (Initiate locate command function before phone goes bone dead)

While the description above refers to particular embodiments of the present invention, it will be understood that many modifications may be made without departing from the spirit thereof. The presently disclosed embodiments are therefore to be considered in all respects as illustrative and not restrictive.

1. A device comprising of a commercial grade Cellphone charging station, wherein the whole system is a standalone and solar powered for cellphone charging. The system will be tracked and traceable upon any displacement for original location.

2. A device according to claim 1, will collect the sun's rays using a solar panel during the day, and convert it to electrical power for usage in the day and night time.

3. A device according to claim 2, will store or retain the converted electrical power in a storage, Lead Acid Battery bank.

4. A device according to claim 1 and 2, will consist of a charge controller to regulate the charging process for, over charged, undercharged and avoid battery damage due to the mentioned reasons.

5. A device according to claim 3 will have the Lead Acid Battery residing in a storage compartment.

6. A device according to claim 1, wherein the system is coin operated for charging power actuation for the duration of the inserted coins value.

7. A device according to claim 6, will have a coin receiver devise integrated with a solenoid component to identify, accept or reject tokens or coins inserted to process actuation for charging.

8. A devices according claim 7, will have the solenoid power fed from the Lead Acid Battery.

9. A device according to claim 2, wherein the system is magnetic stripe card actuated for charging.

10. A device according to claim 3, wherein the system can also be a free standing charging station without any coin insert or switch actuation function.

11. A device according to claim 1, wherein the system is integrated with LED overhead lighting for security around the charging station at night.

12. A device according to claim 2, wherein the system will have an app to process charging activation command remotely from a powered phone device.

13. A device according to claim 6 and 7 will have an operating face comprising of USB ports, coin processing device, and also a magnetic stripe and credit card swipe device as a form of payment for power charging service.

14. A device according to claim 3, will have an LED indicator and to signal the system charging source port.

15. A device according to claim 3, will comprise of a volt meter to indicate the threshold level of power stored for usage on an ongoing period (day or night time).

16. A device according to claim 2, will consist of a power inverted device for switching the DC power to Ac power for any appliance usage.

17. A device according to claim 1, will comprise of capabilities of being tracked or traced or located by any tracking device in case of any authorized or unauthorized displacement.

18. A device according to claim 15, will comprise a Wi-Fi device/interface card for remote access.
